(19) United States
(12) Patent Application Publication
(10) Pub. No.: US 2013/0235422 A1
(43) Pub. Date: Sep. 12, 2013

(54) PRINTING SYSTEM AND METHOD THEREOF

(71) Applicant: CANON KABUSHIKI KAISHA, Tokyo (JP)

(72) Inventor: Hiroaki Nakata, Kawasaki-shi (JP)

(73) Assignee: CANON KABUSHIKI KAISHA, Tokyo (JP)

(21) Appl. No.: 13/787,611

(22) Filed: Mar. 6, 2013

(30) Foreign Application Priority Data
Mar. 9, 2012 (JP) 2012-053498

(51) Int. Cl. G06F 3/12

(52) U.S. Cl. CPC G06F 3/1296
USPC 358/1.15

(57) ABSTRACT

A printing system includes an information processing apparatus and a portable terminal. The information processing apparatus generates an intermediate data format intermediate job, returns, in response to a job information request from the portable terminal, job information of a spooled intermediate job, and transmits, in response to a printing request from the portable terminal, a job generated from spooled intermediate job to an output destination identified based on information in the printing request. The portable terminal transmits a job information request to the information processing apparatus, displays a list of jobs based on received job information, and receives selection of a job to be printed from the jobs list. The portable terminal also reads information regarding an output destination from a printing apparatus by using a reading device and transmits the printing request including information of the selected job and information regarding an output destination to the information processing apparatus.

### BACKGROUND OF THE INVENTION

1. Field of the Invention

The present invention relates to a technology in a printing system for printing print data obtained by a printing apparatus requesting the print data from an external information processing apparatus.

2. Description of the Related Art

Conventionally, a printing system referred to as “pull print” or “anywhere-print” has been discussed. The printing system obtains print data to output the print data by a printing apparatus requesting the print data temporarily stored in an information processing apparatus such as a server based on an instruction of a user via an operation unit. This system allows a user to go to front of a desired printing apparatus and then instruct the printing apparatus to output a print data without instructing any identified printing apparatus to carry out outputting at the time of printing from an application.

Japanese Patent Application Laid-Open No. 2007-304881 discusses a system as a reprinting unit used when print outputting unintended by the user is carried out. The system displays a user interface (UI) of a printer driver operated on a client personal computer (PC) on a panel of a printing apparatus, and operates the UI to give instruction for print setting for reprinting.

A print setting method in the conventional anywhere-print is premised on inclusion of an operation unit (panel) allowing inputting of setting or the like in the printing apparatus. As long as the printing apparatus includes a rich panel having a plurality of operation buttons to be able to display not only characters but also images, there is no problem for executing appropriate setting. However, in a printing apparatus such as a compact laser beam printer or an ink jet printer that includes only a small operation unit (panel), in many cases, only several rows of characters can be displayed, and it is difficult to carry out appropriate print setting. Thus, it is not realistic to assume that the user is caused to operate complex print setting in any printing apparatus by using the panel of the printing apparatus.

### SUMMARY OF THE INVENTION

The present invention is directed to a method for realizing anywhere-print allowing flexible print setting irrespective of display capability of a panel included in a printing apparatus.

According to an aspect of the present invention, a printing system includes an information processing apparatus, wherein the information processing apparatus includes a job generation unit configured to generate, according to user's instruction, an intermediate job that is an intermediate data format, a spool unit configured to spool the generated intermediate job, a response unit configured to return, in response to a job information request from a portable terminal, job information of the spooled intermediate job, and a transmission unit configured to transmit, in response to a printing request from the portable terminal, a job generated from the spooled intermediate job to an output destination identified based on information regarding the output destination included in the printing request, and the portable terminal, wherein the portable terminal includes: a first requesting unit configured to transmit a job information request to the information processing apparatus, a display unit configured to display a list of jobs based on job information received from the information processing apparatus, an input unit configured to receive selection of a job to be printed from the list of jobs, a reading unit configured to read information regarding an output destination from a printing apparatus by using a reading device included in the portable terminal, wherein the printing apparatus is configured to carry out print processing of a received job, and a second requesting unit configured to transmit the printing request including information of the selected job and information regarding an output destination to the information processing apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating a configuration example of a printing system.

FIG. 2 is a block diagram illustrating a hardware configuration of a client PC, a smartphone, and a printer.

FIG. 3 is a diagram illustrating a main software configuration and a data flow in the client PC.

FIG. 4 is a diagram illustrating a main software configuration in the smartphone.

FIG. 5 is a sequential diagram illustrating a flow of setting-up processing.

FIG. 6, which is composed of FIGS. 6A and 6B, is a sequential diagram illustrating a flow of print processing.

FIGS. 7A and 7B are diagrams each illustrating a display example of a setting-up screen displayed in the client PC.

FIGS. 8A and 8B are diagrams each illustrating a screen example displayed in the smartphone.

FIGS. 9A and 9B are diagrams each illustrating various data in the printing system configuration example.

FIGS. 10A and 10B are diagrams each illustrating various data in the printing system configuration example.

FIG. 11 is a diagram illustrating correspondence relationship between a file system and a uniform resource locater (URL) converted by Internet services.

FIGS. 12A, 12B, 12C, 12D, and 12E are diagrams each illustrating various data transmitted in communication processing.

### DESCRIPTION OF THE EMBODIMENTS

Various exemplary embodiments, features, and aspects of the invention will be described in detail below with reference to the drawings. In an example, job information spooled in a client PC is displayed on a smartphone owned by a user, and user's input of selection of a job to be printed or a print setting change is received. When the smartphone is held over an IC chip mounted on a printer that is a desired output destination, the smartphone reads information regarding the output destination from the IC chip by an IC card reader, and issues printing instruction based on the user's input and the information regarding the output destination to the client PC, thereby realizing print processing.

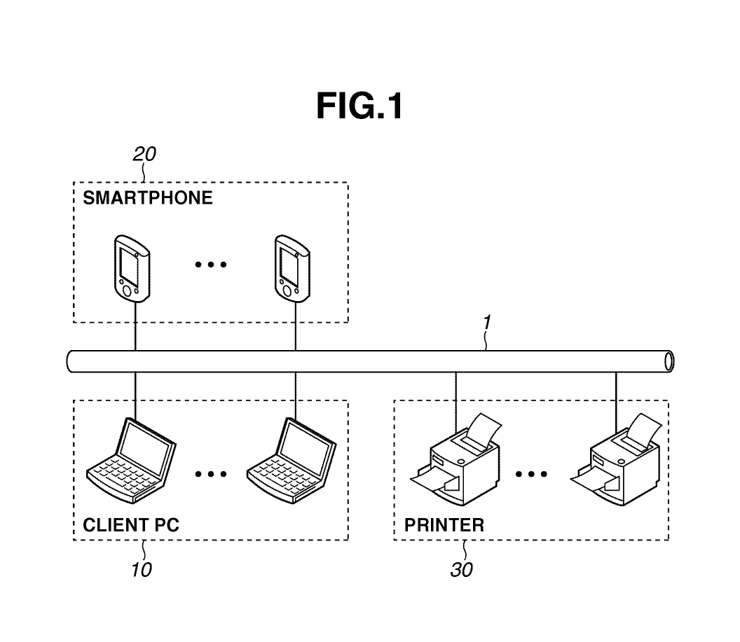

FIG. 1 is a diagram illustrating a configuration example of a printing system according to the present exemplary embodiment. The printing system according to the present exemplary embodiment includes a plurality of client PCs 10, a plurality of smartphones 20, and a plurality of printers 30, which are interconnected via a local area network (LAN) 1.

When the present exemplary embodiment is applied to an office environment, a target is that when the number of users is N, the number of client PCs 10 is equal to that of users, namely, N, and the number of printers 30 is smaller than N, namely, M (M<N). Hereinafter, therefore, description will be based on these numbers. Assuming use as a user's individual terminal as in the case of the client PC 10, the number of smartphones 20 is N equal to that of users. For each apparatus, there is no particular restriction on a type of a physical connection method to the LAN 1. However, generally, the client PC 10 and the printer 30 are configured with wired LAN, while smartphone 20 is configured with wireless LAN. Thus, description will be based on this assumption.

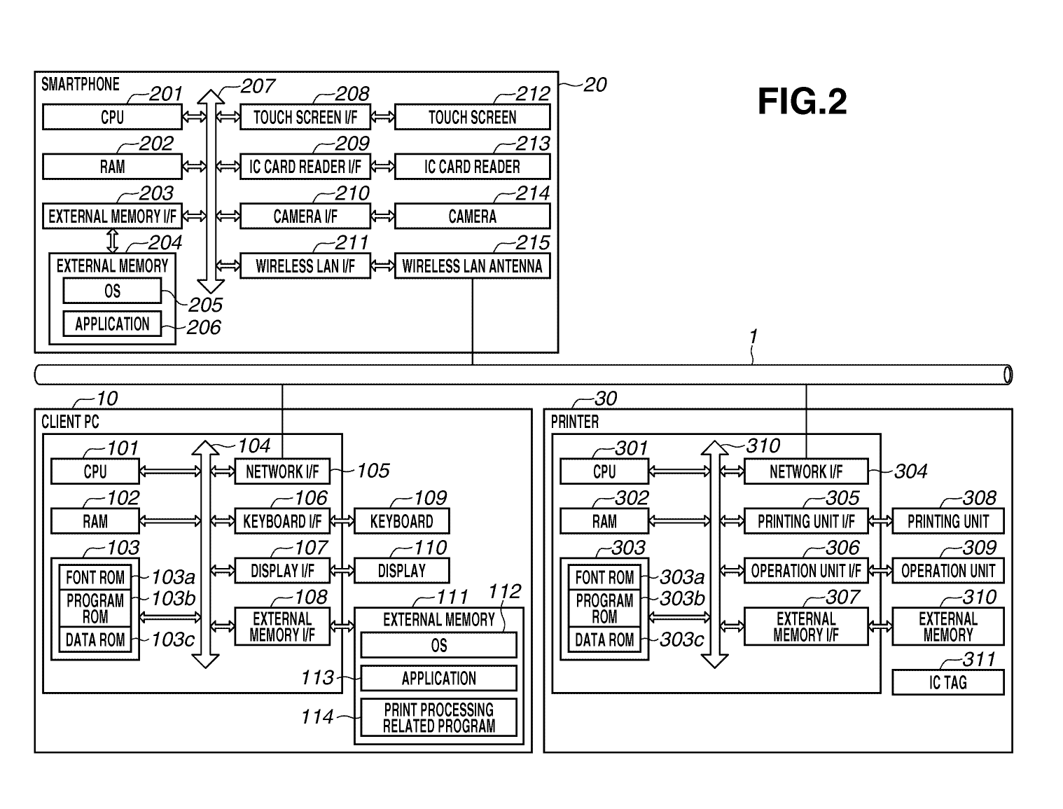

FIG. 2 is a block diagram illustrating a hardware configuration of an information processing apparatus applicable to each apparatus.

First, the client PC 10 will be described. A central processing unit (CPU) 101 collectively controls devices connected to a system bus 104 according to a program stored in a random access memory (RAM) 102. The RAM 102 also functions as a main memory or a work area of the CPU 101. A read-only memory 103, which stores various programs and data, is divided into a font ROM (103a) for storing various fonts, a program ROM 103b for storing a boot program or a basic input/output system (BIOS), and a data ROM 103c for storing various data. A network interface (I/F) 105 is connected to the LAN 1 to carry out communication processing.

A keyboard controller I/F 106 controls a key input from a keyboard 109 or a pointing device (mouse) (not shown). A device I/F 107 controls display processing on a display 110. An external memory I/F 108 controls access with an external memory 111 such as a hard disk (HD). The external memory 111 functions as a computer readable storage medium for storing various applications 113 such as an operating system (OS) 112 and a print processing related program 114, in addition to a user file and a edit file (not shown).

As the OS 112, Microsoft Windows is used. The print processing related program 114 includes a plurality of programs, which will be described below.

Next, the smartphone 20 will be described.

A CPU 201 collectively controls devices connected to a system bus 207 according to a program stored in a RAM 202. The RAM 202 also functions as a main memory or a work area of the CPU 201. A ROM 204, which is a storage device of various programs or data, stores an OS 205 and application 206 as data. As the OS 205, for example, Android is mounted, and as the application 206, an application operated on the Android is used. Other types of OSs can be applied by carrying out almost similar application designing. A touch screen I/F 208 executes display processing on a touch screen 212 or control processing of an input operation such as touching or sliding from the user. An IC card reader I/F 209) controls an IC card reader 213 to read an IC tag 310 associated with the printer 30 described below. A camera I/F 210 executes imaging control of a camera 214 or processing such as conversion of an input image signal into electronic image data.

A wireless LAN I/F 211 controls a wireless LAN antenna 215, and executes communication processing with the LAN 1 connected via the wireless LAN antenna 215.

In the present exemplary embodiment, the smartphone 20 is taken as an example of a portable terminal. However, other portable communication terminals such as a portable telephone or a personal digital assistance (PDA) can be used.

Lastly, a configuration of the printer 30 will be described.

A CPU 301 collectively controls devices connected to a system bus 304 according to a program stored in a RAM 302. The RAM 302 also functions as a main memory or a work area of the CPU 301, and is used as an output information rasterization region or an environment data storage region.

The RAM. 302, which includes a nonvolatile RAM (NVRAM) region, is configured to increase a memory capacity by an optional RAM connected to an expansion port (not shown). A ROM 303 includes a font ROM 303a for storing various fonts, a program ROM 303b for storing a control program executed by the CPU 301, and a data ROM 303c for storing various data. A network I/F 305 is connected to the LAN 1 to carry out communication processing. A printing unit I/F 305 controls an interface with a printing unit 308 serving as a printer engine. An operation unit 309 controlled by an operation unit I/F 306 includes an operation panel for receiving a user's operation. Switches for operations and a liquid crystal display (LED) are arranged on the operation panel (not shown).

The present exemplary embodiment assumes a problem, specifically, when operability of the switches and display capability of the display included in the printer 30 are low, it is extremely difficult for the user to check or input various pieces of information regarding printing in the printer 30. Thus, it is assumed that device specifications of the operation unit 309 are simple, allowing displaying of only several rows of character information.

Even if the device specifications of the operation unit 309 are at a high level including a touch panel, embodiments can be applied. This case is beneficial in that the user can carry out, without depending on operability unique to the printer, print processing with similar operation feelings by a process described below.

An external memory I/F 307 controls access with an external memory 310 such as an HD. The external memory 310 stores font data, an emulation program, and form data. The number of the external memories 310 is not limited to one. A plurality of external memories 310 may be installed. For example, a plurality of external memories storing an optional font card in addition to a built-in font or a program for interpreting a printer control language of a different language system may be connected.

The CPU 301, which can carry out communication processing with the client PC 10 via the network I/F 304, receives printer-description language (PDL) data transmitted from the client PC 10. The CPU 301 can output, based on the control program stored in the ROM 303b of the ROM 303, an image signal obtained by converting the print data to the printing unit 308 via the printing unit I/F 305.

An IC tag 311 is a type of radio frequency identification (RFID) being a compact electronic device operated by receiving a radio wave. In the present exemplary embodiment, as the IC tag, a noncontact type readable by the IC card reader 213 built into the smartphone 20 is used. Because of the noncontact type, information stored in the IC tag 311 can be read only by lightly touching the IC tag 311 with the IC card reader 213. The IC tag 311 is stuck to the exterior of the printer 30 or fixed to an apparatus body by using an attachment.

The IC tag 311 associated with the apparatus body is used for identifying one of the printers amounting to M in number. As information for this purpose, an ID number unique to each tag and unrewritable is stored in the IC tag 311.

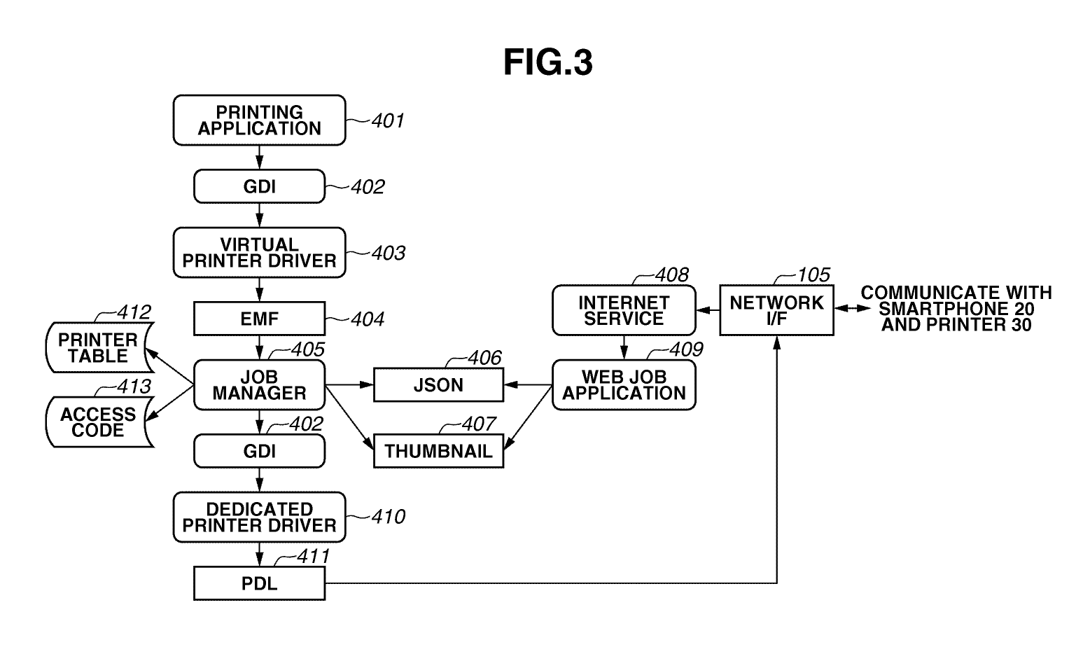

FIG. 3 illustrates software and hardware configurations concerning the printing system of the present exemplary embodiment and a rough data flow in the client PCs 10.

A printing application 401 is used for creating a document to be printed by the user and giving printing instruction. A graphic device interface (GDI) 402 is a rendering interface provided by the OS 112. The printing application 401 outputs a print instruction command via the GDI 402. A virtual printer driver 403 and a dedicated printer driver 410 are types of printer drivers. The dedicated printer driver 410 converts the printing instruction command input from the GDI 402 into a PDL 411 to transmit the PDL 411 to the printer 30 via the network I/F 105.

In the present exemplary embodiment, since the M number of printers 30 is installed, a plurality of types of corresponding dedicated printer drivers 410 is prepared beforehand according to a number of models included in the printers 30. To allow transmission of the PDL 411 to a network address (Internet Protocol (IP) address) allocated to each of the M number of printers 30, a print queue and a port are set beforehand.

On the other hand, the virtual printer driver 403 converts, instead of directly transmitting data to the printer 30, the printing instruction command input from the GDI 402 into an enhanced meta file (EMF) 404 to output the EMF to a print job manager 405. The EMF 404, which has an intermediate data format compatible to the printing instruction command, records a series of printing instruction commands input from the GDI 402 as data to be subsequently reproduced.

In the present exemplary embodiment, the EMF 404 is used as the intermediate data format. However, as long as data can reproduce the printing instruction command, for example, extensible markup language (XML) paper specification (XPS) or an independently defined arbitrary intermediate data format may be used. Further, since the virtual printer driver 403 uses the intermediate data format for the purpose of outputting, only one type needs to be installed.

The job manager 405 is software for playing a central role in the printing system of the present exemplary embodiment. Specifically, the job manager 405 carries out spool processing of the EMF 404, generation of thumbnails 407 as a series of print preview images, communication processing with a web job application 409, and despool processing of the EMF 404.

A printer table 412 is an information table referred to by the job manager 405 to determine a printer of an output destination from information stored in the IC tag. An access code (413) is a unique code generated by the job manager 405 when the job manager 405 is installed. The Internet service 408 concerns a hosting system of web services provided by the OS 112, which carries out processing of releasing a web page or a web application to an external terminal via the LAN 1.

The web job application 409 is operated based on the Internet services 408. The web job application 409 receives a request from the smartphone 20, executes processing associatively with the job manager 405, and transmits a response to the smartphone 20. JavaScript object notification 406 is a data format used for communication between the web job application 409 and the job manager 405.

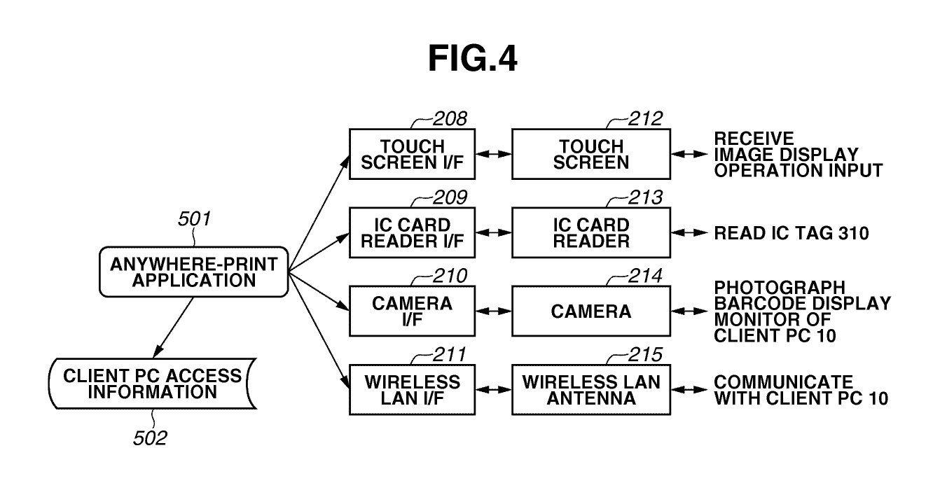

FIG. 4 illustrates main software and hardware configurations in the smartphone 20.

An anywhere-print application 501 is operated on the OS 205. Client PC access information 502 is generated by the anywhere-print application 501 and stored in the external memory 204.

The anywhere-print application 501 controls the touch screen I/F 208, the IC card reader I/F 209, the camera I/F 210, and the wireless LAN I/F 211 via the CPU 201 and the bus 207, and transfers data to and from the touch screen 212, the IC card reader 213, the camera 214, and the wireless LAN antenna 215.

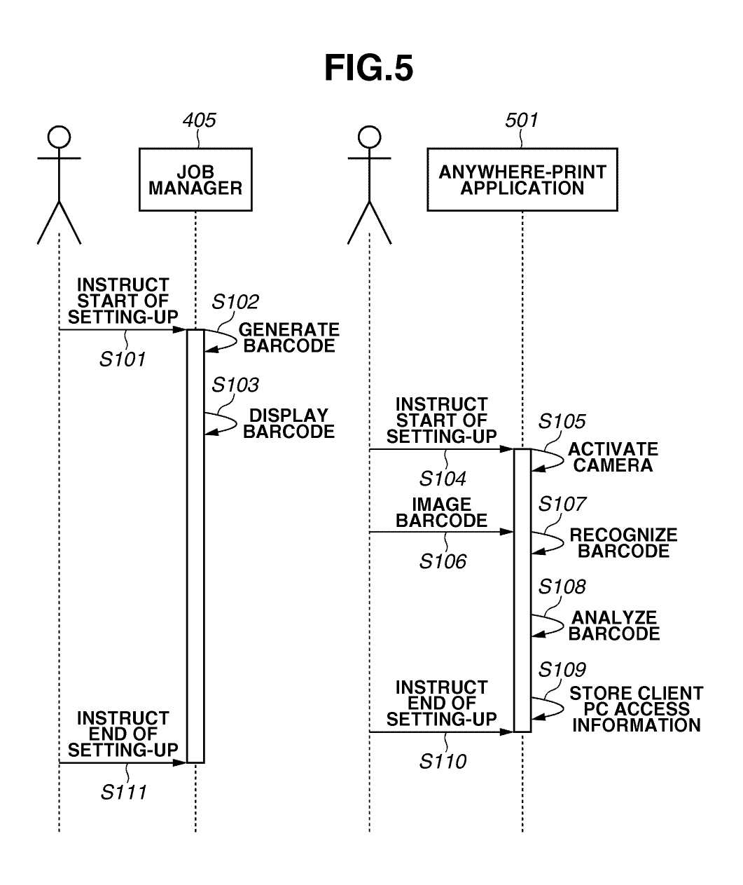

FIG. 5 is a sequential diagram illustrating setting-up processing of the printing system according to the present exemplary embodiment.

In the printing system according to the present exemplary embodiment, the user operates both the client PC 10 and the smartphone 20 used as individual terminals to realize print processing. Thus, not only a printing related program such as the job manager 405 and the anywhere-print application 501 should be respectively installed in the client PC 10 and the smartphone 20, but also both terminals should be associated with each other. The setting-up processing illustrated in FIG. 5 is carried out during an operation for associating, after the installation of such software has been completed, the job manager 405 with the anywhere-print application 501 to set them in a mutually communicable state.

First, in step S101, the job manager 405 on the client PC 10 receives a setting-up start instruction from a user's input operation. In step S102, the job manager 405 generates a two-dimensional barcode coding client PC access information 502. In step S103, the job manager 405 displays the two-dimensional barcode on the display 110.

Then, in step S105, the anywhere-print application 501 in the smartphone 20 detects the setting-up start instruction from the user's input operation (step S104). In step S105, the anywhere-print application 501 controls the camera I/F 210 to activate the camera 214, and starts imaging processing. In step S106, the user photographs the two-dimensional barcode displayed on the display 110 to be within a photographing range of the camera 214. In step S107, the anywhere-print application 501 analyzes an input image to recognize the two-dimensional barcode.

Then, in step S108, the anywhere-print application 501 analyzes the two-dimensional barcode recognized in step S108 to decode the information. In step S109, the anywhere-print application 501 stores client PC access information 502 decoded in step S109 in the external memory 204.

Lastly, in steps S110 and S111, the anywhere-print application 501 and the job manager 405 ends the setting-up processing when they respectively receive setting-up end instructions from the user.

In the foregoing, the two-dimensional barcode is used when the client PC access information 502 is transmitted from the client PC to the smartphone. However, wired communication such as a universal serial bus (USB) or wireless communication such as infrared rays may be used.

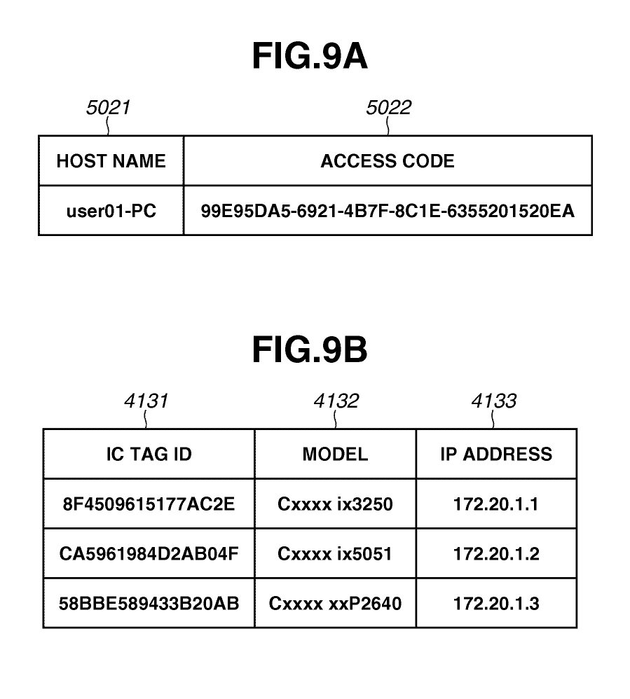

FIG. 9A illustrates an example of the client PC access information 502. The client PC access information 502 includes a host name 5021 and an access code 5022.

The host name 5021 is host name information of the client PC. The numbers of smartphones 20 and client PCs 10 are both N, and the smartphone 20 communicates with the client PC 10 during a printing operation described below. In this case, as information for determining which of the N clients PCs 10 the smartphone 20 accesses, host name information of “user01-PC” is used in the present exemplary embodiment. In a case where the IP address of the client PC 10 is unchanged, information of the IP address is used for the host name 5021.

The access code 5022 is character string information of an arbitrary length, and a globally unique identifier (GUID) is used in the present exemplary embodiment. The access code 5022) is simple authentication information used when the anywhere-print application 501 starts communication with the job manager 405 at the time of printing operation. The job manager 405 generates, when the job manager 405 is installed in the client PC 10, a unique access code 413 to store the unique access code 413 in the external memory 111. Since the job manager 405 installed in each of the N client PCs 10 generates a unique access code 413, N access codes are present. The access code 5022 on the smartphone 20 is a result of obtaining the access code 413 stored in the client PC 10 by setting-up processing. The job manager 405 determines whether to permit or reject communication by determining whether the access code 5022 received by the anywhere-print application 501 and the access code 413 stored in the external memory 111 match each other at the time of starting communication for print processing. As a result, only the client PC 10 and the smartphone 20 associated with each other by the setting-up processing are permitted to communicate with each other, and this prevents a printed document from being seeing watched by other users by mistake.

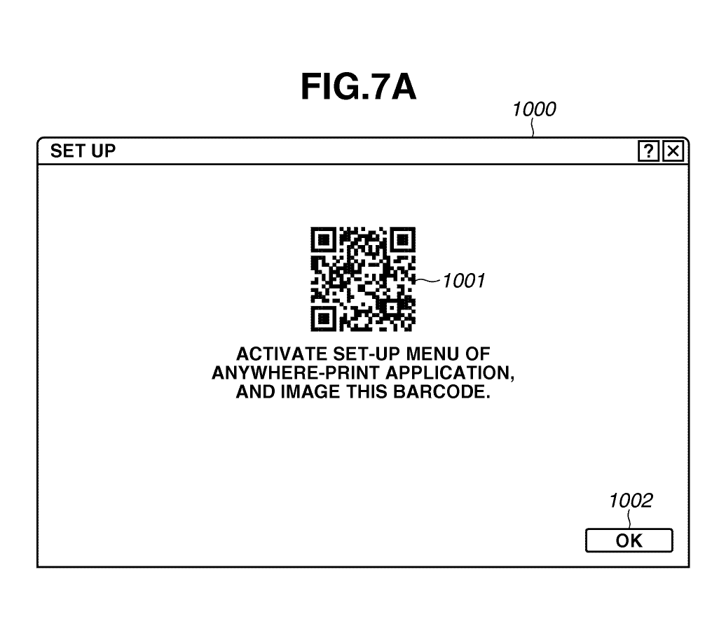

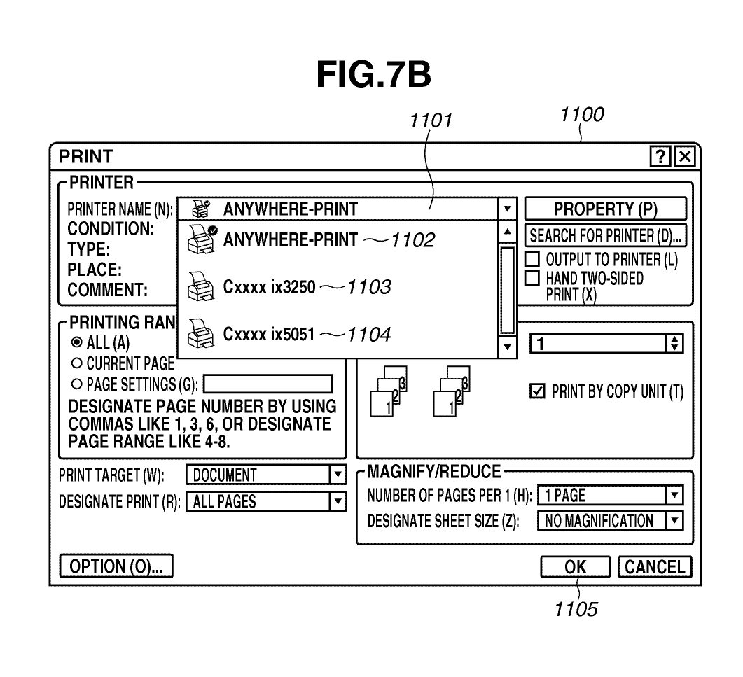

FIG. 7A illustrates an example of a setting-up screen 1000 of the job manager 405 displayed on the display 110.

The two-dimensional barcode 1001 is a barcode image obtained in step S102 by coding the client PC access information 502. As an example of the barcode image, a case of using a quick response (QR) code is illustrated. Setting-up is completed only by capturing the two-dimensional barcode displayed on the display 110 by the camera 214 of the smartphone 20. Thus, a burden on the user is reduced as compared with a method when the same information amount is input by characters. By pressing an OK button 1002, setting-up end instruction is transmitted to the job manager.

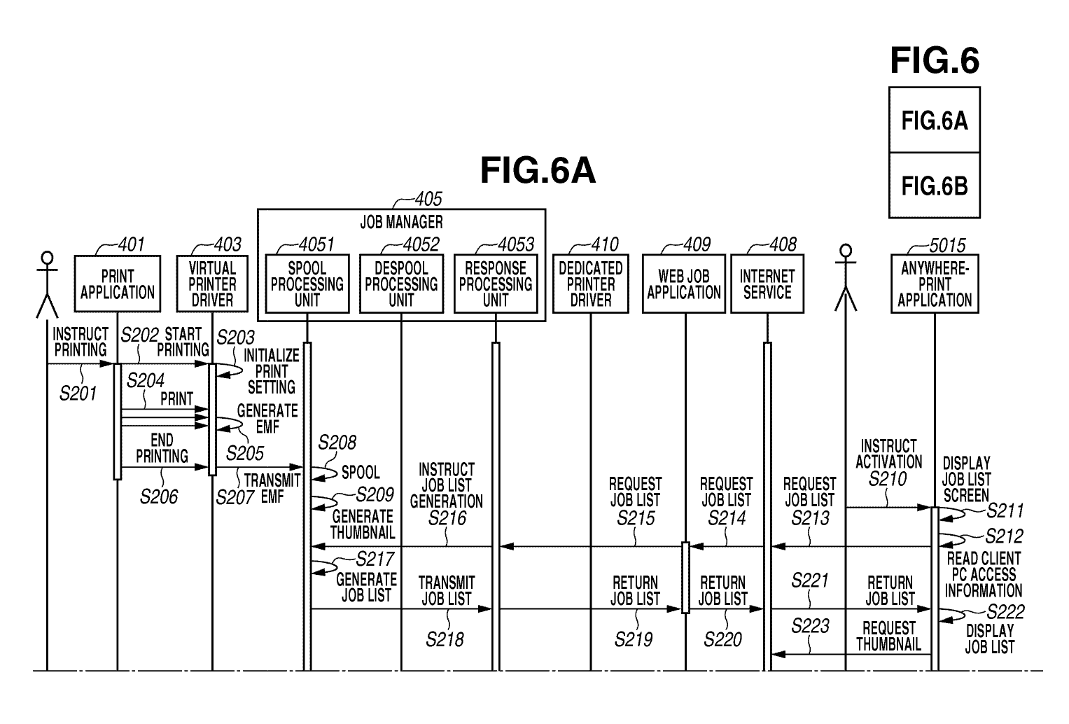

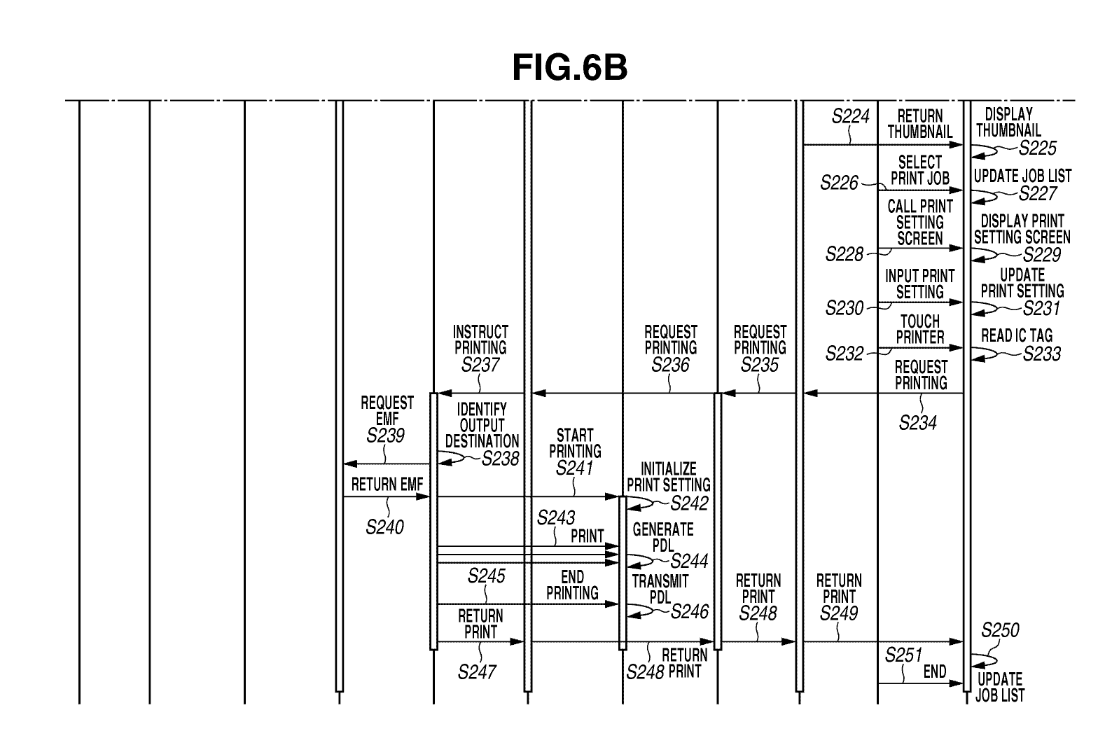

FIG. 6, which is composed of FIGS. 6A and 6B, is a sequential diagram illustrating print processing of the printing system according to the present exemplary embodiment.

A rough flow of the print processing will first be described, and then each process will be described in detail. The point is that, as described above, the user of the printing system operates both of the client PC 10 and the smartphone 20 to output a print.

First, when the user inputs printing instruction of a print document on the client PC 10 to the printing application 401, the virtual printer driver 403 carries out print processing. Without outputting any data to the actual printer 30, the virtual printer driver 403 converts a print job into EMF 404 to transmit the EMF 404 to the job manager 405. The job manager 405 temporarily reserves the EMF on the client PC 10.

Secondly, when the same user who has left the client PC 10 and taken out the smartphone 20 activates the anywhere-print application 501, the anywhere-print application 501 is activated. The anywhere-print application 501 communicates with the job manager 405 of the client PC 10, obtains a list of stored print jobs, and displays information together with a thumbnail on the smartphone (20). The anywhere-print application 501 receives an input operation of a print setting change from the user, detects touching of a desired printer (IC tag thereof) selected among the M printers, and then instructs printing to the job manager 405.

Lastly, the job manager 405 that has received the printing instruction from the smartphone 20 carries out print processing via the dedicated printer driver 410, and outputs a print to the printer 30.

The specific flow of the print processing will be described based on the above described outline of the print processing.

First, in step S201, the printing application 401 in the client PC 10 receives printing instruction of the print document from the user. Then, in step S202, the printing application 401 starts print processing to the virtual driver 403 via the GDI 402.

FIG. 7B illustrates a screen example 1100 for inputting the printing instruction in the printing application 401, which is displayed on the display 110. A choice “anywhere-print” 1102 is currently selected by a print queue selection unit 1101. The “anywhere-print” 1102 indicates selection of a print queue corresponding to the virtual printer driver 403.

Other choices in the list, namely, “Cxxxxix3250” 1103 and “Cxxxx ix5051” 1104 indicate selection of a print queue corresponding to the dedicated printer driver 410. If anyone of the print queues is selected and an OK button 1105 is pressed by a mouse, the printing application 401 carries out print processing via the printer driver corresponding to each print queue. In the present exemplary embodiment, since anywhere-print is executed, a print queue of “anywhere-print” 1102 is selected.

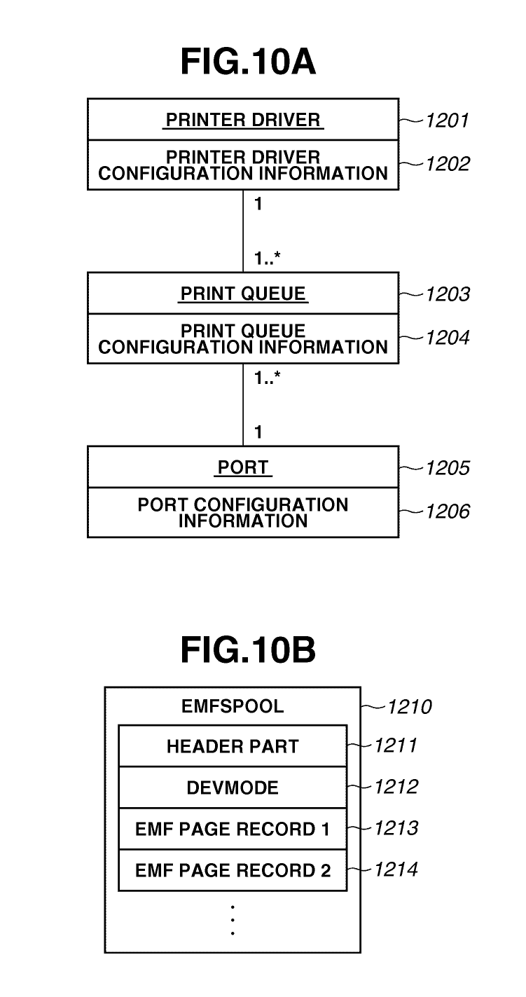

Referring to FIG. 10A, a relationship among a printer driver, a print queue, and a port will be described. The relationship is illustrated by using an object diagram of a unified modeling language (UML).

The OS 112 manages three types of objects, namely, a printer driver 1201, a print queue 1203, and a port 1205 so that the user can easily install the printer driver and print a document. These objects are managed by the OS 112 in a manner that they are stored as information in the external memory 111 and can be accessed from a program such as the printing application 401 via an application programming interface (API).

The printer driver 1201 is an object indicating the virtual printer driver 403 and the dedicated printer driver 410 installed in the OS 112. The printer driver 1201 becomes another object if a model is different since the printer driver 1201 is managed for each model.

The print queue 1203 is a target object when the program carriers out print processing via a printing API. The print queue 1203 is managed in association with the printer driver 1201. A plurality of print queues 1203 can be associated with one printer driver 1201.

The port 1205 is an object for identifying an output destination. Normally, one port 1205 is managed in association with one print queue 1201. For example, when three printers of “Device Model A” are installed in an office, typically, the dedicated printer driver 410 corresponding to the Device Model A is installed, one printer driver 1203, three print queues 1203, and twenty two ports 1205 are created to be associated with one another.

The objects respectively store printer driver configuration information 1202, print queue configuration information 1204, and port configuration information 1206. The printer driver configuration information 1202 includes information such as a model name, a driver version, hardware information, or a driver module name. The print queue configuration information 1204 includes information such as a print queue name, a printer driver name, a port name, print setting information, or access right information. The port configuration information 1206 includes information such as a port name, address information (IP address), or a port module name.

If a printer driver is installed, in other words, if an object of the printer driver 1201 is present, the program can generate objects of the print queue 1203 and the port 1205 via a setting-up API.

The description is returned to FIG. 6.

In step S203, after the print processing has been started, the virtual printer driver 403 carries out initialization processing of print setting according to print setting information input by the print starting command of step S202. If the OS 112 is the Windows, and an intermediate format to be spooled is EMF 404, the format of a DEVMODE structure is used as print setting. The DEVMODE structure is binary data including information such as a function usable by the printer, layout setting, finish setting, sheet feeding setting, sheet discharge setting, and printing quality setting.

Subsequent to the printing start, in step S204, the printing application 401 inputs a print rendering command equivalent to print rendering of each page to the virtual printer driver 403. Then, in step S205, the virtual printer driver 403 converts the print rendering command into EMF 404. At the time of the conversion into the EMF (404), the DEVMODE structure initialized in step S203 is included in the EMF (404) so that the print setting information of the print job is stored.

Referring to the schematic diagram of FIG. 10B, a data structure of the EMF 404 will be described.

EMFSPOOL 1210 is a format to define a structure capable of storing a plurality of data therein. In the present exemplary embodiment, the EMFSPOOL 1210 includes data 1211 to 1214. The EMFSPOOL 1210 represents data itself handled in transmission processing or storage processing. For convenience, the data is referred to as EMF 404 when handled in the program. The header part 1211 is data indicating information such as a generation date or job information. The DEVMODE 1212 is data of the above described DVEMODE structure. The EMF page record 1 1213, the EMF page record 2 1214, and a series of subsequent data record a print rendering command of each page of the print job.

Again, the description is returned to FIG. 6.

In step S206, the printing application 401 inputs a printing end command to the virtual printer driver 403. In step S207, the virtual printer driver 403 transmits the generated EMF 404 to the spool processing unit 4051 of the job manager 405. As a method for transmitting the EMF 404 to the spool processing unit 4051, a named pipe is used. The processing of steps S202 to S207 may be carried out sequentially or in parallel (in random order).

In step S208, the spool processing unit 4051 writes and stores the EMF 404 in the external memory 111 to spool (temporarily reserve) the received EMF 404. Then, in step S209, the spool processing unit 4051 generates a thumbnail 407 from the received EMF 404 to store the thumbnail 407 in the external memory 111. The thumbnail 407 refers to a preview image of each page included in the print job. In the present exemplary embodiment, an image of a joint photographic experts group (JPEG) format small in file size and suited to displaying on the smartphone 20 is generated and stored.

If other documents to be printed are present, by receiving printing instruction again from the user, the processing of steps S201 to S209 is carried out.

Thus, the processing accompanied by the operation in the client PC 10 is ended, and then the process proceeds to a next processing carried out by the user operating the smartphone 20.

In the smartphone 20, in step S210, an input of activation instruction of the anywhere-print application 501 from the user is detected and the anywhere-print application 501 is activated. In step S211, the anywhere-print application 501 displays an initial screen for displaying a job list. Then, in step S212, the anywhere-print application 501 reads the client PC access right information 502 stored in the external memory 204 in step S109 illustrated in FIG. 5. In steps S213 and S214, the anywhere-print application 501 transmits a job list request using the client PC access right information 502 to the web job application 409 by hyper text transfer protocol (HTTP) via the Internet service 408.

In step S215, the web job application that has received the job list request transmits the job list request with a named pipe to a response processing unit 4053 responsible for response processing of the job manager 405. In step S216, the response processing unit 4053 that has received the job list request instructs the spool processing unit 4051 to generate job list information. In step S217, the spool processing unit 4051 generates job list information. In step S218, the response processing unit 4053 receives the generated job list information. In step S219, the response processing unit 4053 returns the job list information to the web job application 409. In steps S220 and S221, the web job application 409 returns the received job list information to the anywhere-print application 501 via the Internet service 408.

The communication processing of steps S213 to S221 will be described in detail.

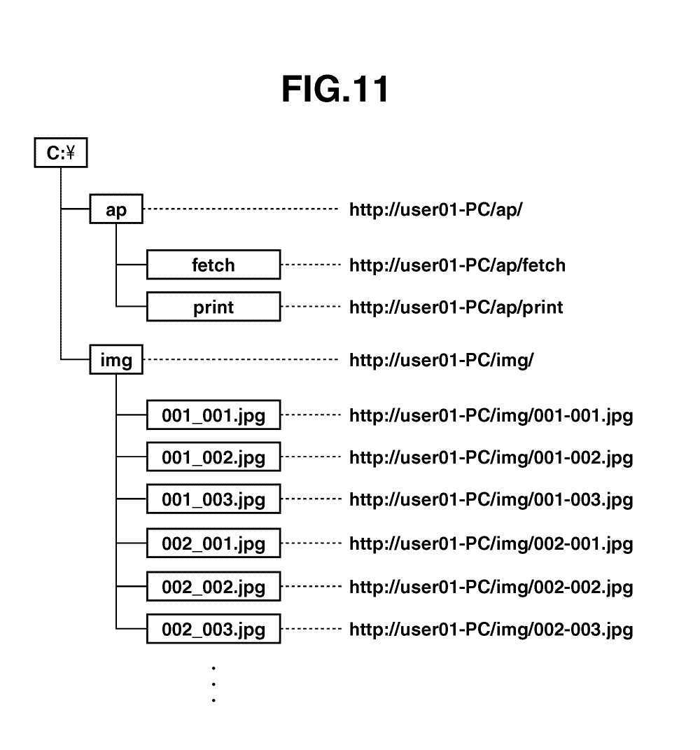

FIG. 11 is a schematic diagram illustrating correspondence between a file system and URL of web contents released by the Internet service (408).

In the Internet service 408, processing of releasing a folder object and a file object of a file system provided by the OS 112 as a web content to the outside via the LAN 1. One of the functions of the web job application 409 is to convert a file object of “C:/ap/fetch” stored in the external memory 111 on the file system, by the Internet service 408, into a web content represented by a URL of “http://user01-PC/ap/fetch” to be released.

The anywhere-print application 501 of the smartphone 20 can transmit the job list request by executing communication with the URL as a target by using HTTP protocol. In elements constituting the URL, a portion of a host name indicating an address of the HTTP communication, a value “user0′-PC” of the host name 5021 included in the client PC access information 502 is designated. A portion of a script name subsequent to the host name is changed according to a function of the web application (409) to be called up.

In this case, since a job list acquisition request is transmitted, “/ap/fetch” is designated. At the time of transmission of a printing request described below, “/ap/print” is designated.

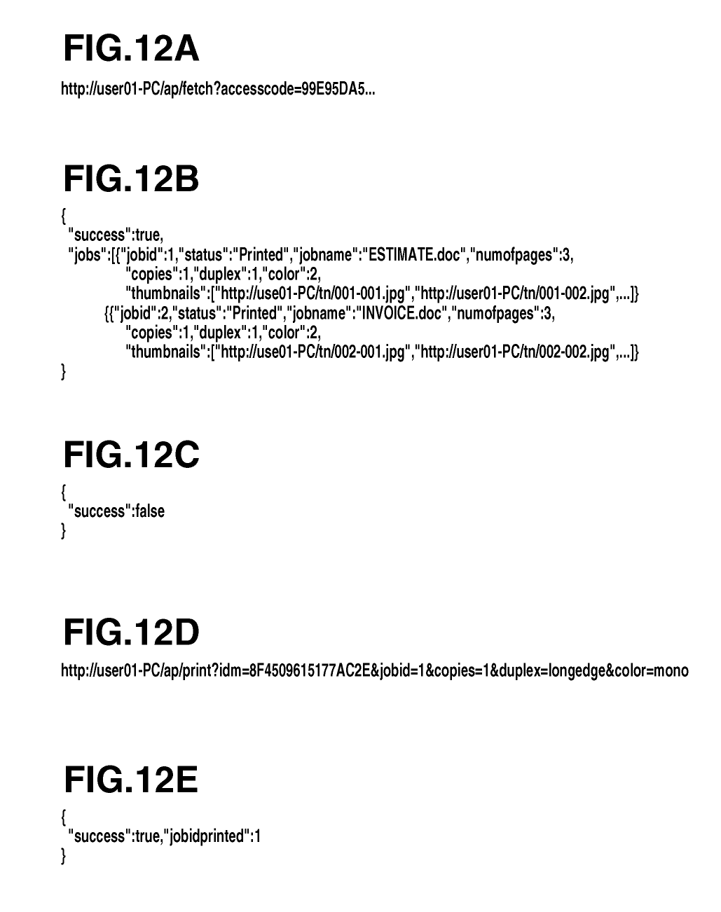

At the time of the transmission of the job list request, the access code 5022 obtained in the setting-up processing should be transmitted as a parameter. This parameter is, as illustrated in FIG. 12A, a query string of URL. In other words, a character string of “?accesscode=99E95DA5 . . . ” is added after the aforementioned URL.

In step S213, when HTTP communication is carried out by using the URL illustrated in FIG. 12A, a value of the URL itself is directly transmitted to the response processing unit 4053 via the Internet service 408 and the web job application 409. The response processing unit 4053 can determine, by analyzing the received URL, what request (job list acquisition request or printing request) has been received with what parameter.

FIG. 12B illustrates an example of data returned as a response. The response is transmitted in a JavaScript Object Notation (JSON) format. In the JSON format, information is represented by a pair of a key and a value. For example, information as to whether communication processing has been successful is represented by ““success”: true”. Continuous list information is represented by using a bracket. This representation allows description of information about a plurality of jobs spooled in the client PC 10 similar to a value of “jobs”.

The information regarding the job list illustrated in FIG. 12B includes information about whether the communication processing succeeds, a list of included jobs, a job ID of each job, a job name, and the number of pages. As print setting of each job, information such as copy number setting, two-sided setting, or color setting is included. Further, URL list information for obtaining a thumbnail for each page included in each job is included.

Images of the thumbnails generated in step S209 are stored as a plurality of file objects such as “C:/img/001_{—}001.jpg” in the file system of the OS 112 illustrated in FIG. 11. These file objects are released as a plurality of URLs such as “http://user01-PC/img/001_{—}001.jpg” by the Internet service 408, and each image has been set in an obtainable state by communication. The obtainment of each image will be described below.

As described above referring to FIG. 9A, the job manager 405 determines whether the access code 5022 received from the anywhere-print application 501 and the access code 413 stored in the external memory 111 match each other to determine whether to permit communication. If matched, the JSON data illustrated in FIG. 12B is transmitted. If not matched, JSON data illustrated in FIG. 12C is transmitted. In FIG. 12C, data is ““success”: false”, indicating rejection of communication.

Again, the description is returned to FIG. 6.

In step S222, the anywhere-print application 501 displays a job list screen based on the obtained job list information. Then, in step S223, the anywhere-print application 501 takes out URL list information of the thumbnails included in the job list information, carries out HTTP communication targeting each URL, and requests a print preview image of each page. In step S224, the anywhere-print application 501 obtains image data as a response. In step S225, the anywhere-print application 501 that has obtained the print preview image of each page displays the print preview image on the job list screen as needed.

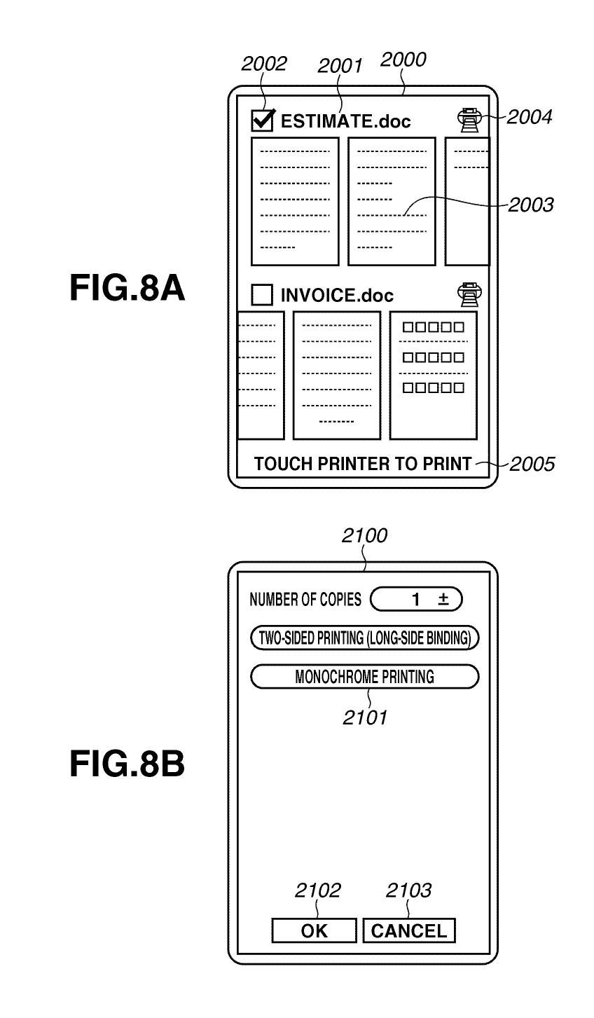

FIG. 8A illustrates an example of a job list screen 2000 displayed on the touch screen 212 of the smartphone 20. Components such as a job name 2001, a check button 2002, a thumbnail container 2003, and a print setting button 2004 are arranged on the screen. Information about one job is displayed by a unit collecting these components. By displaying a plurality of units, information is comprehensively represented as a job list. In the screen example, information of “estimate.doc” is displayed by using an upper half of the touch screen 212, and information of “invoice.doc” is displayed by using a lower half. If there is a third job in addition to these, the user can display its information by vertically scrolling the screen by a touching operation.

The thumbnail container 2003 is a region for displaying the preview image of each page. In the screen example, preview images of two pages and half are displayed, enlarged to full in lateral direction of the touch screen 212. When checking preview images of the third page and after, the user can display information by horizontally scrolling the screen by a touching operation.

The message 2005 is a region for displaying a message for assisting a user's operation.

In a series of processing (steps S211 to S225) for displaying the job list screen, the following process may be carried out to shorten time until the pieces of information including the thumbnails are displayed and reduce stress on the user.

For example, at the time when the processing of step S222 ends, no thumbnail has been obtained. Thus, an image representing a blank paper is displayed as a dummy. In the case of a great volume where the number of spooled jobs is 10 and the number of pages included in each job is 50, when displaying is not updated until thumbnails of total of 500 pages are obtained, the user feels stress. Accordingly, the anywhere-print application 501 determines a job ID and a page number of a job to be obtained from a position of the thumbnail container 2003 actually displayed on the touch screen 212, and requests only a relevant thumbnail in step S223. If the screen is moved by a user's operation, the anywhere-print application 501 determines a thumbnail to be obtained from a position of the moved thumbnail container, and requests and obtains image data each time.

Again, the description is returned to FIG. 6.

In step S227, the anywhere-print application 501 detects a selection input (step S226) of a job to be printed from the user to update the job list screen. In step S229, the anywhere-print application 501 detects an instruction input (step S228) of print setting from the user to display a print setting screen. In step S231, the anywhere-print application 501 detects an input (step S230) of the print setting on the print setting screen from the user to update print setting information according to the print setting.

The check button 2002 illustrated in FIG. 8A is a component for receiving a selection input of a print target job. In a default state, which is an ON state being checked, the job is included in a print target. If the check is released by pressing the check button 2002 to set an OFF state, the job is removed from the print target. Such a selection input is utilized for printing a particular job subsequently or outputting a certain job by a color printer and then printing the rest by a monochromatic printer.

FIG. 8B illustrates an example of a print setting screen 2100 displayed on the touch screen 212 of the smartphone 20. The print setting screen 2100 is displayed by pressing the print setting button 2004 arranged as a component for each job. A component 2101 is for setting each item of print setting. An input unit configured to execute copy setting, two-sided setting, or color setting is displayed. After the change of the component 2101, the change can be determined by pressing an OK button 2102, and canceled by pressing a cancel button 2103. Through such determination or cancellation, the job list screen 2000 is displayed again.

The anywhere-print application 501 stores and updates the print setting information of each job in the JSON format illustrated in FIG. 12B or a similar format.

Again, the description is returned to FIG. 6.

The anywhere-print application 501 detects that the IC tag 312 fixed to the printer 30 as a desired output destination is touched (step S232) with the smartphone 20 by the user, and in step S233, the anywhere-print application 501 reads information of the IC tag.

The anywhere-print application 501 controls, upon activation, the IC card reader 213 via a CPU 201, the bus 207, and the IC card reader I/F 209, and instructs notification simultaneously with reading of the IC tag 312. After the IC tag 312 has been read, the IC card reader I/F 209 notifies the anywhere-print application 501 of the read information. The read information includes IC tag ID information unique to the IC tag. In the present exemplary embodiment, the IC tag 312 is associated with each of the M printers 30. Accordingly, the number of IC tag IDs is also M. The printing system of the present exemplary embodiment determines which of the printers 30 has been selected as a desired output destination based on the IC tag ID.

Then, in step S234, the anywhere-print application 501 transmits a printing request by using the IC tag ID, the job ID to be printed, and desired print setting as parameters. In steps S235 and S236, the printing request is transmitted, by the similar communication method to that of the job list request, to the response processing unit 4053 via the Internet service 408 and the web application (409).

FIG. 12D illustrates an example of the printing request to be transmitted. In this example, an access code is not included as a parameter. However, the access code may be included as in the case of the processing of the job list request. The printing request is, as clear from parameter specifications, transmitted for each printing request of one job.

Then, in step S237, the response processing unit 4053 instructs printing to the despool processing unit 4052. In step S238, the despool processing unit 4052, when instructed to execute printing, refers to information of a printer model 4132 and an IP address 4133 as print targets in the printer table 412 to identify a print queue to be printing processing target. If no relevant print queue is present, a new print queue is created, and the created print queue is set as a print target to update the printer table 412.

FIG. 9B illustrates an example of the printer table 412. The table includes IC tag ID 4131, a model 4132, and an IP address 4133. The table 412 is created beforehand by an administrator who introduces the printing system of the present exemplary embodiment, and installed in the client PCs 10 together with the program of the job manager 405. Alternatively, in view of material updating of the printer 30, the table may be subsequently distributed to allow updating.

After the print queue of the print target has been determined, in step S239, the despool processing unit 4052 requests data of the EMF 404 relevant to the print-requested JOB ID to the spool processing unit 4051. In step S240, the despool processing unit 4052 obtains EMF data as a response. Then, the despool processing unit 4052 interprets the EMF 404 to reproduce the printing instruction command, and outputs a series of printing instruction commands to the dedicated printer driver 410 corresponding to the print queue. Specifically, in step S241, the despool processing unit 4052 issues a printing start command. In step S243, the despool processing unit 4052 transmits data corresponding to each actual page. In step S245, the despool processing unit 4052 issues a printing end command.

In step S242, for these commands, the dedicated printer driver 410 initializes the print setting. In step S244, the dedicated printer driver 410 generates PDL based on the received data. In step S246, the dedicated printer driver 410 actually transmits the PDL generated in step S246 to the printer 30 via the network I/F 105.

The processing of steps S241 to S246 may be carried out sequentially or randomly as in the case of steps S202 to S207.

When issuing the printing start command in step S241, the despool processing unit 4052 changes a DEVMODE structure 1212 included in the EMF 404 according to information of print setting included in the printing request from the anywhere-print application 501. As a result, an output can be obtained from the printer 30 in a desired print style changed by the user.

In step S247, the despool processing unit 4052 returns, in response to the end of the print processing, the end of the print processing to the response processing unit 4053. In step S248, the response processing unit 4053 transmits this response to the web job application 409. Further, in step S249, the web job application 409 transmits a response indicating the end of the print processing to the anywhere-print application 501.

FIG. 12E illustrates an example of a print response. JSON format data of the print response includes, for checking, information of printed job ID as ““jobidprinted”: 1” together with a success status of the communication processing.

In step S250, the anywhere-print application 501 that has received the print response updates the job list information by deleting the information of the printed job, and displays the job list information. Then, in step S251, the anywhere-print application 501 receives end instruction from the user to end the program.

According to the present exemplary embodiment, after the data of a printing target has been selected by the smartphone, only by touching the printer in a manner of holding the smartphone overt the printer, desired data can be print outputted to the printer without any work such as an operation of the operation unit of the printing apparatus. In other words, the user can carry out print processing by “anywhere-print” with uniform operation feelings without any dependence on operability or display capability of the printer.

A first of the other exemplary embodiments will be described. As a different form for implementing the embodiment, the method for identifying the printer as the desired output destination may be changed. As a method other than that of reading the IC tag 312 by the IC card reader 213, a method for imaging a barcode stuck to each printer 30 by the camera 214 to recognize the barcode can be applied. In addition, a proximate wireless communication technology such as IrDA (infrared communication standard) can be applied.

A second of the other exemplary embodiments will be described. As a different form for implementing the embodiment, a server PC may be added as an apparatus configuration of the printing system. In the foregoing embodiments, the job manager 405 is operated on each use's client PC 10. However, the job manager 405 is operated on the server PC installed in the printing system, and similar processing is applied. This case is beneficial in that setting-up processing is not necessary because the communication target of the anywhere-print application 501 is the job manager 405 on the predetermined server PC.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiment(s). The computer may include one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. In an example, a computer-readable storage medium may store a program that causes a printing system and/or a portable terminal to perform a method described herein. In another example, a central processing unit may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-053498 filed Mar. 9, 2012, which is hereby incorporated by reference herein in its entirety.

What is claimed is:

1. A printing system comprising:
an information processing apparatus, wherein the information processing apparatus includes:
a job generation unit configured to generate, according to user's instruction, an intermediate job that is an intermediate data format,
a spool unit configured to spool the generated intermediate job,
a response unit configured to return, in response to a job information request from a portable terminal, job information of the spooled intermediate job, and
a transmission unit configured to transmit, in response to a printing request from the portable terminal, a job generated from the spooled intermediate job to an output destination identified based on information regarding the output destination included in the printing request; and
the portable terminal, wherein the portable terminal includes:
a first requesting unit configured to transmit a job information request to the information processing apparatus,
a display unit configured to display a list of jobs based on job information received from the information processing apparatus,
an input unit configured to receive selection of a job to be printed from the list of jobs,
a reading unit configured to read information regarding an output destination from a printing apparatus by using a reading device included in the portable terminal, wherein the printing apparatus is configured to carry out print processing of a received job, and
a second requesting unit configured to transmit the printing request including information of the selected job and information regarding an output destination to the information processing apparatus.

2. The printing system according to claim 1, wherein the reading device included in the portable terminal is an integrated circuit (IC) chip reading device configured to read information managed by an IC chip fixed to an outside or an inside of the printing apparatus.

3. The printing system according to claim 1,
wherein the information processing apparatus further includes a preview image generation unit configured to generate a print preview image from the intermediate job,
wherein the portable terminal further includes a third requesting unit configured to request a preview image generated by the information processing apparatus, and
wherein the display unit displays a preview image obtained in response to a request from the third requesting unit.

4. A method in a printing system, the method comprising:
generating, using an information processing apparatus and according to user's instruction, an intermediate job that is an intermediate data format;
spooling, using the information processing apparatus, the generated intermediate job;
returning, using the information processing apparatus and in response to a job information request from a portable terminal, job information of the spooled intermediate job;
transmitting, using the information processing apparatus and in response to a printing request from the portable terminal, a job generated from the spooled intermediate job to an output destination identified based on information regarding the output destination included in the printing request;
transmitting, using the portable terminal, a job information request to the information processing apparatus;
displaying, using the portable terminal, a list of jobs based on job information received from the information processing apparatus;
receiving, using the portable terminal, selection of a job to be printed from the list of jobs;
reading, using the portable terminal, information regarding an output destination from a printing apparatus by using a reading device included in the portable terminal, wherein the printing apparatus is configured to carry out print processing of a received job; and
transmitting, using the portable terminal, the printing request including information of the selected job and information regarding an output destination to the information processing apparatus.

5. A portable terminal configured to communicate with an information processing apparatus holding jobs according to user's instruction, the potable terminal comprising:
a display unit configured to display a list of jobs based on job information received from the information processing apparatus;
an input unit configured to receive selection of a job to be printed from the list of jobs;
a reading unit configured to read information regarding an output destination from a printing apparatus by using a reading device included in the portable terminal; and
a second requesting unit configured to transmit the printing request including information of the selected job and information regarding an output destination to the information processing apparatus,
wherein, in response to a printing request from the portable terminal, a job corresponding to the information of the selected job is transmitted from the information processing apparatus to the printing apparatus identified based on information regarding the output destination included in the printing request.

6. The portable terminal according to claim 5, wherein the reading device included in the portable terminal is an integrated circuit (IC) chip reading device configured to read information managed by an IC chip fixed to an outside or an inside of the printing apparatus.

7. The portable terminal according to claim 6, wherein the information regarding the output destination read by the reading unit is identification information unique to the IC chip, and
wherein the information processing apparatus identifies from the identification information a printing apparatus as the output destination.

8. The portable terminal according to claim 5, further comprising a third requesting unit configured to request a preview image generated by the information processing apparatus,
wherein the display unit displays a preview image obtained in response to a request from the third requesting unit.

9. A method in a portable terminal configured to communicate with an information processing apparatus holding jobs according to user's instruction, the method comprising:
displaying a list of jobs based on job information received from the information processing apparatus;
receiving selection of a job to be printed from the list of jobs;
reading information regarding an output destination from a printing apparatus by using a reading device included in the portable terminal; and
transmitting the printing request including information of the selected job and information regarding an output destination to the information processing apparatus,
wherein, in response to a printing request from the portable terminal, a job corresponding to the information of the selected job is transmitted from the information processing apparatus to the printing apparatus identified based on information regarding the output destination included in the printing request.

10. A non-transitory computer readable storage medium storing a program causing a portable terminal to perform the method according to claim 9.
